(19) United States
(12) Patent Application Publication
(10) Pub. No.: US 2021/0135701 A1
(43) Pub. Date: May 6, 2021

(54) Mobile Device Case Insert

(71) Applicant: Jill Megehee, Richland, WA (US)

(72) Inventor: Jill Megehee, Richland, WA (US)

(21) Appl. No.: 17/070,462

(22) Filed: Oct. 14, 2020

Related U.S. Application Data
(60) Provisional application No. 62/931,475, filed on Nov. 6, 2019.

(51) Int. Cl. H04B 1/3888

(52) U.S. Cl. CPC H04B 1/3888; H04M 1/0283

(57) ABSTRACT

A mobile device case insert is provided. The mobile device case insert includes an insert body having an exterior surface opposite an interior surface, wherein the insert body is dimensioned to removably secure within a mobile device case. Indicia is disposed across the exterior surface. A tab is pivotally affixed to the insert body on the interior surface, wherein the tab is selectively movable between an extended position and a collapsed position. The tab is coplanar with the insert body when in the collapsed position. The mobile device case insert may further have a cutout that extends through the insert body, wherein the cutout corresponds to a camera or other feature of the mobile device.

### CROSS REFERENCE TO RELATED APPLICATIONS

This application claims the benefit of U.S. Provisional Application No. 62/931,475 filed on Nov. 6, 2019. The above identified patent application is herein incorporated by reference in its entirety to provide continuity of disclosure.

### BACKGROUND OF THE INVENTION

The present invention relates to mobile device cases. More particularly, the present invention pertains to a mobile device case insert that provides a desired aesthetic appeal to a mobile device case while being easily removable therefrom.

Many individuals enjoy personalizing their electronic devices, such as smartphones, tablets, and the like. Oftentimes, these individuals utilize a decorative cover having a desired aesthetic appearance, however, such covers are not typically customizable. Therefore, whenever an individual wishes to change the appearance of their device, they must purchase a new case. This can be initially cost-prohibitive to certain individuals, thereby preventing them from expressing themselves in a desired way. For others, these costs can become excessive over time, requiring new replacement cases for a particular desired appearance. Furthermore, if the individual has several different cases for coordinating with an existing outfit, such cases can be difficult to store, as they take up a large amount of space. Therefore, a readily interchangeable decorative insert for a mobile device case that allows a user to change the appearance and allow full function of a camera or other feature of their electronic device is desired.

In light of the devices disclosed in the known art, it is submitted that the present invention substantially diverges in design elements from the known art and consequently it is clear that there is a need in the art for an improvement to existing mobile device cases. In this regard, the instant invention substantially fulfills these needs.

### SUMMARY OF THE INVENTION

In view of the foregoing disadvantages inherent in the known types of mobile device cases now present in the known art, the present invention provides a mobile device case insert wherein the same can be utilized for providing convenience for the user when modifying the appearance of the mobile device case via an interchangeable insert.

The present system comprises an insert body having an exterior surface, wherein the insert body is dimensioned to removably secure within a mobile device case. In some embodiments, the mobile device case includes a base having a plurality of perimeter side walls defining an interior volume configured to receive the insert body therein. In such embodiments, a portion of the mobile device case is transparent. Indicia is disposed across the exterior surface of the insert body. A tab is pivotally affixed to the insert body on an interior surface thereof, wherein the tab is selectively movable between an extended position and a collapsed position. The tab is coplanar with the insert body when in the collapsed position.

In some embodiments, the insert body comprises an exterior layer affixed to an interior layer, wherein the exterior layer comprises the indicia thereon. In another embodiment, the interior layer comprises a rigid structure. In other embodiments, the tab is defined within the interior layer by a series of cuts extending along a distal end and opposing lateral sides of the tab. In yet another embodiment, a lower end of the tab is pivotally secured to the interior layer. In some embodiments, the exterior layer comprises a greater cross-sectional area than the interior layer defining a lip. In another embodiment, a QR code is disposed on an interior surface of the insert body, wherein the QR code is configured to correspond to the indicia, such that when the QR code is scanned, the indicia is replicated on a mobile device display. In other embodiments, a cutout extends through the insert body, wherein the cutout corresponds to a camera or other feature of a mobile device. In yet another embodiment, a distal end of the tab comprises an arcuate edge.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the mobile device case insert with a mobile device and a mobile device case.

FIG. 2 shows a front view of an embodiment of the mobile device case insert.

FIG. 3 shows a rear view of an embodiment of the mobile device case insert.

FIG. 4 shows a cross-sectional view of an embodiment of the mobile device case insert.

### DETAILED DESCRIPTION OF THE INVENTION

Reference is made herein to the attached drawings. Like reference numerals are used throughout the drawings to depict like or similar elements of the mobile device case insert. The figures are intended for representative purposes only and should not be considered to be limiting in any respect.

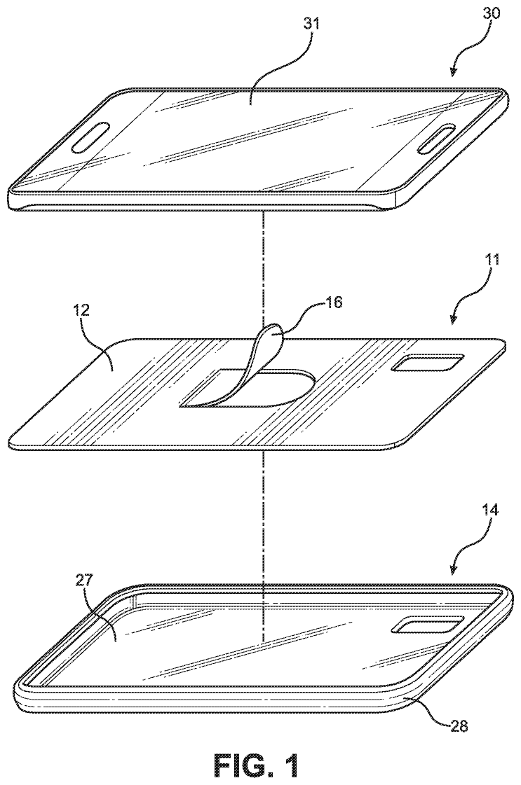

Referring now to FIG. 1, there is shown an exploded view of an embodiment of the mobile device case insert with a mobile device and a mobile device case. The mobile device case insert 11 comprises an insert body 12 dimensioned to secure within a mobile device case 14. In the illustrated embodiment, the insert body 12 comprises a single rigid layer removable securable within the mobile device case 14, wherein the rigid layer is configured to provide structural stability minimizing the risk of damage when the mobile device case insert 11 is inserted or removed. In this manner, the user can ensure that the insert body 12 can be readily interchanged with alternate insert bodies 12 as desired. The insert body 12 further comprises a tab 16 pivotally affixed thereto. In the illustrated embodiment, the tab 16 is selectively movable from a collapsed position coplanar with the insert body 12 to an extended position. The tab 16 can be extended to provide the user a gripping surface to facilitate removal of the insert body 12 from the mobile device case 14.

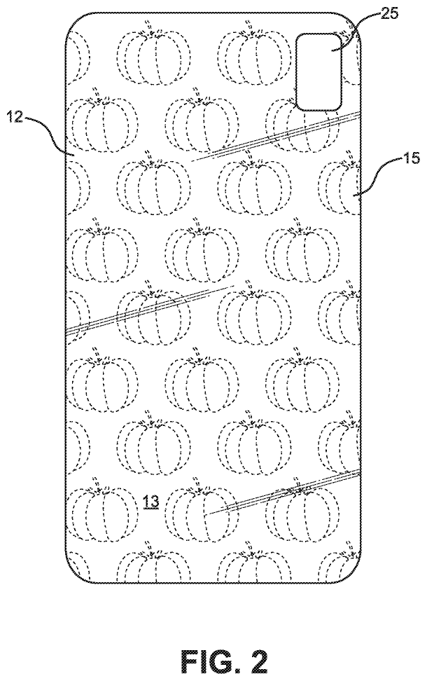

In the shown embodiment, the mobile device case 14 comprises a base 27 having a perimeter sidewall 28 extended therefrom, defining an interior volume, wherein the perimeter sidewall 28 is dimensioned to retain a mobile device 30 therein via frictional engagement. The insert body 12 can be inserted into the mobile device case 14 such that an exterior surface (as shown in FIG. 2, 18) thereof rests against the base 27. The mobile device 30 can then be inserted into the mobile device case 14 atop the insert body 12 such that a display 31 of the mobile device 30 is opposite the base 27. In the illustrated embodiment, the mobile phone case 14 comprises at least one transparent portion configured to allow an indicia (as shown in FIG. 2, 15) disposed on the exterior surface of the insert body 12 to be visible therethrough. In some such embodiments the entirety of the base 27 is transparent to maximize visibility of the indicia or pattern on the insert body 12. In this manner, the user can customize the appearance of the mobile device case 14 to suit a desired aesthetic.

Referring now to FIG. 2, there is shown a front view of an embodiment of the mobile device case insert. In the illustrated embodiment, indicia 15 are disposed across an entirety of an exterior surface 13 of the insert body 12. The indicia 15 are contemplated to include a variety of patterns, shapes, designs, or logos as desired by a user. Various insert bodies 12 having different indicia 15 are contemplated to be interchangeably used with a mobile device, such that a user can readily alter the appearance of their mobile device to suit a variety of situations. For example, the user could desire to pair their mobile device with a particular season, event, or outfit, and having one of several insert bodies 12 for each desired appearance allows the user to efficiently alter the mobile device's appearance without the need to purchase additional mobile device cases.

In the illustrated embodiment, the insert body 12 further comprises a cutout 25 therethrough, wherein the cutout 25 is positioned and dimensioned to conform to the shape and size of a mobile device camera or other feature. In this manner, the insert body 12 does not interfere with the operation of the mobile device camera or other feature when in use. Furthermore, in the shown embodiment, the exterior surface 18 comprises an additional layer having the indicia 15 thereon such that the tab is not visible when the insert body 12 is in use. This multi-layer embodiment will be described in further detail elsewhere herein.

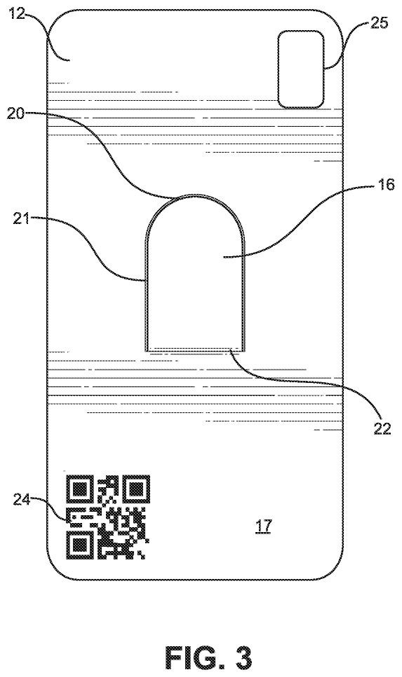

Referring now to FIG. 3, there is shown a rear view of an embodiment of the mobile device case insert, respectively. The insert body 12 further comprises an interior surface 17 opposite the exterior surface, wherein the interior surface 17 is configured to rest flush against the mobile device when the insert body 12 is in use. Similar to the embodiment described above, the cutout 25 can be disposed in an appropriate corner of the insert body 12 to allow a mobile device camera or other feature to operate unimpeded therethrough. In the illustrated embodiment, the tab 16 is shown in the collapsed position coplanar with the insert body 12. The tab 16 is defined within the insert body by a series of cuts extending along opposing lateral sides 21 of the tab 16 and a distal end 20 of the tab, such that the tab 16 is pivotally affixed to the insert body along a lower end 22 thereof. In the shown embodiment, the tab 16 comprises an arcuate distal end 20. The arcuate distal end 20 provides a comfortable protrusion with no sharp edges for grasping to move the tab 16 into an extended position.

In the illustrated embodiment, the insert body 12 further comprises a OR code 24 printed on the interior surface 17 thereof. The QR code 24 is configured to correspond to the pattern of indicia disposed on the exterior surface such that upon being scanned the display of the mobile device is configured to replicate the pattern of indicia thereon. In this manner, the user can synchronize their mobile device's background, theme or other elements to the indicia of the insert body 12. In some embodiments, the QR code 24 corresponds to an exact duplicate of the indicia disposed on the exterior surface, whereas in alternate embodiments, the QR code 24 corresponds to an image similar to the indicia, such that the background or display of the mobile device can present a similar theme to the indicia.

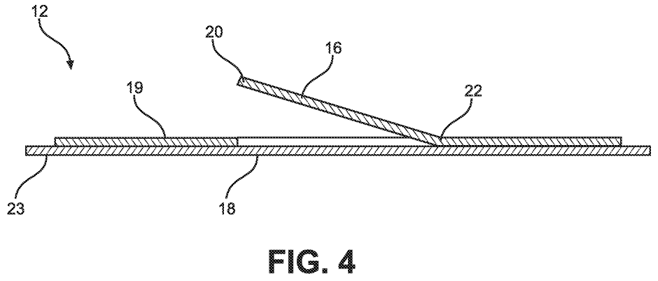

Referring now to FIG. 4, there is shown a cross-sectional view of an embodiment of the mobile device case insert. In the illustrated embodiment, the insert body 12 comprises an interior layer 19 affixed to an exterior layer 18. In the shown embodiment, the exterior layer 18 comprises the indicia thereon, whereas the tab 16 is defined entirely within the interior layer 19. In this manner, the tab 16 is not visible through the exterior layer 18 when the insert body 12 is within a mobile device case, ensuring a continuous and unbroken design or pattern. Similar to the previously described embodiments, the tab 16 is defined by a series of cuts along opposing lateral sides and the distal end 20 thereof, such that the tab 16 is pivotally affixed to the interior layer 19 along a lower end 22 thereof. The tab 16 is further configured to move between a collapsed position coplanar with the interior layer 19, and an extended position to provide a gripping surface for the user to remove the insert body 12 from the mobile device case.

In some embodiments, the interior layer 19 comprises a rigid material to provide structural integrity and durability to the insert body 12. In the illustrated embodiment, the interior layer 19 comprises a smaller cross-sectional area than the exterior layer 18, such that a lip 23 is defined about a perimeter of the interior layer 19. In some such embodiments, the exterior layer 18 comprises a flexible material, such that the lip 23 can fold along the perimeter sidewalls of the mobile device case when inserted within the interior volume. In such embodiments, the lip 23 frictionally engages the perimeter sidewalls. Furthermore should the perimeter sidewalk be transparent similar to the base of the mobile device case, the lip 23 allows the indicia to be shown through the perimeter sidewalk when in use.

In one use, the insert body 12 is inserted into a mobile device case with a transparent base, such that the exterior surface of the insert body 12 is visible therethrough. The mobile device can then be inserted into the mobile device case such that the insert body 12 is sandwiched between the mobile device and the mobile device case. In some embodiments, the user can scan a QR code disposed on the interior surface of the insert body 12 to replicate the pattern or indicia on the exterior surface on the mobile device display. In this manner, the mobile device and the mobile device case can be synchronized to produce the desired aesthetic. Should the user desire to change the appearance, the mobile device can be removed from the case and the tab 16 extended from the insert body 12 to provide a gripping surface. The user can then grip the tab 16 to remove the insert body 12, followed by replacing the insert body 12 with a separate insert body 12 having a desired design. In this manner, the user can easily and efficiently interchange insert bodies 12 to define a desired aesthetic appeal without needing to purchase additional mobile device cases.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A mobile device case insert, comprising:
an insert body having an exterior surface opposite an interior surface, wherein the insert body is dimensioned to removably secure within a mobile device case;
indicia disposed across the exterior surface;
a tab pivotally affixed to the insert body on an interior surface thereof;
wherein the tab is selectively movable between an extended position and a collapsed position;
wherein the tab is coplanar with the insert body when in the collapsed position.

2. The mobile device case insert of claim 1, wherein the insert body comprises an exterior layer affixed to an interior layer, wherein the exterior layer comprises the indicia thereon.

3. The mobile device case insert of claim 2, wherein the interior layer comprises a rigid structure.

4. The mobile device case insert of claim 2, wherein the tab is defined within the interior layer by a series of cuts extending along a distal end and opposing lateral sides of the tab.

5. The mobile device case insert of claim 4, wherein a lower end of the tab is pivotally secured to the interior layer.

6. The mobile device case insert of claim 2, wherein the exterior layer comprises a greater cross-sectional area than the interior layer defining a lip.

7. The mobile device case insert of claim 1, further comprising a QR code on an interior surface of the insert body, wherein the QR code is configured to correspond to the indicia such that when the QR code is scanned, the indicia is replicated on a mobile device display.

8. The mobile device case insert of claim 1, further comprising a cutout extending through the insert body wherein the cutout corresponds to a camera or other feature of a mobile device.

9. The mobile device case insert of claim 1, wherein a distal end of the tab comprises an arcuate edge.

10. A mobile device case insert, comprising:
an insert body having an exterior surface opposite an interior surface;
a mobile device case having a base and a plurality of perimeter sidewalk defining an interior volume configured to receive a mobile device therein;
wherein the insert body is dimensioned to removably secure within the interior volume;
indicia disposed across the exterior surface;
a tab pivotally affixed to the insert body on an interior surface thereof;
wherein the tab is selectively movable between an extended position and a collapsed position;
wherein the tab is coplanar with the insert body when in the collapsed position.

11. The mobile device case insert of claim 10, wherein the insert body comprises an exterior layer affixed to an interior layer, wherein the exterior layer comprises the indicia thereon.

12. The mobile device case insert of claim 11, wherein the interior layer comprises a rigid structure.

13. The mobile device case insert of claim 11, wherein the tab is defined within the interior layer by a series of cuts extending along a distal end and opposing lateral sides of the tab.

14. The mobile device case insert of claim 13, wherein a lower end of the tab is pivotally secured to the interior layer.

15. The mobile device case insert of claim 11, wherein the exterior layer comprises a greater cross-sectional area than the interior layer defining a lip.

16. The mobile device case insert of claim 10, further comprising a QR code on an interior surface of the insert body, wherein the QR code is configured to correspond to the indicia such that when the QR code is scanned, the indicia is replicated on a mobile device display.

17. The mobile device case insert of claim 10, further comprising a cutout extending through the insert body, wherein the cutout corresponds to a camera or other feature of a mobile device.

18. The mobile device case insert of claim 10, wherein a distal end of the tab comprises an arcuate edge.

19. The mobile device case insert of claim 10, wherein a portion of the mobile device case is transparent.
